(19) United States
(12) Patent Application Publication
(10) Pub. No.: US 2012/0164442 A1
(43) Pub. Date: Jun. 28, 2012

(54) Flame Retardant Multi-Layer Label

(76) Inventors: Kenryuu Ley Keong Ong, Penang (MY); Min He, Shaanxi (CN); Jian Lin, Fujian (CN)

(21) Appl. No.: 13/394,234

(22) PCT Filed: Sep. 10, 2009
(86) PCT No.: PCT/CN09/73854

§ 371 Date: Mar. 5, 2012

(51) Int. Cl. B32B 3/00; B05D 5/10; B32B 7/12

(52) U.S. Cl. 428/336; 428/354; 428/337; 427/207.1

(57) ABSTRACT

The present invention relates to a multi-layer label, including: a backing film having a first surface and a second surface, and a topcoat layer containing a polymeric matrix and a flame retardant and having a first surface and a second surface, the second surface of the topcoat in intimate contact with the first surface of the backing film, in which the label as a whole is in compliance with UL94 VTM-0 standard and comprises less than 900 ppm of chlorine, less than 900 ppm of bromine, and less than 1500 ppm of chlorine and bromine in combination. The multi-layer label may further include a flame retardant layer containing a binder and a flame retardant, and/or an adhesive layer optionally containing a flame retardant. The multi-layer label is useful in electronic products and mass transportation.

### FIELD OF THE INVENTION

The present invention relates to a multi-layer label, in particular to a flame retardant multi-layer label, in more particular to a halogen-free flame retardant multi-layer label, especially a halogen-free flame retardant multi-layer label with good printability useful as an identification label.

### BACKGROUND OF THE INVENTION

Flame retardant labels are used in many situations, where flame retardancy is needed, such as cables, printed circuit boards (PCB) or printed wiring boards (PWB) and batteries as well as in-process bar code and other labeling systems to improve process inventory and quality control.

UL94 VTM-0 is the most stringent test standard for flammability of thin plastic materials released by Underwriters Laboratories Inc. Halogen-based flame retardants are considered to offer high performance of flame retardancy and can be used to meet the requirement of UL94 VTM-0, but they are hindered from being applied in some situations due to the generation of smoke and toxic products during combustion.

For example, halogen flame retardant-containing UL94 VTM-0 labels such as 3M7203 and 3M7204 from 3M and K05013F from SKC are commercially available, but they cannot meet halogen-free requirements, such as International Electromechanical Commission (IEC) standard 61249-2-21, which requires less than 900 ppm of chlorine, less than 900 ppm of bromine and less than 1500 ppm of the combination of chlorine and bromine.

In addition, labels, especially identification labels usually require good printability suitable for printing techniques such as screen printing, dot-matrix, ink jet, laser printing, laser marking, thermal transfer, and so on.

Thus, a printable, flame-retardant, halogen-free label in compliance with UL94 VTM-0 standard and the IEC standard 61249-2-21 is highly desired especially in electronic equipments.

### SUMMARY OF THE INVENTION

In one aspect, the invention provides a multi-layer label, comprising:
a backing film having a first surface and a second surface; and
a topcoat layer comprising a polymeric matrix and a flame retardant and having a first surface and a second surface, the second surface of the topcoat in intimate contact with the first surface of the backing film;
wherein the label as a whole is in compliance with UL94 VTM-0 standard and comprises less than 900 ppm of chlorine, less than 900 ppm of bromine, and less than 1500 ppm of chlorine and bromine in combination.

In an embodiment, the multi-layer label can further comprise a flame retardant layer comprising a binder and a flame retardant(s) and having a first surface and a second surface, and the first surface can be in intimate contact with the second surface of the backing film.

In an embodiment, the multi-layer label can further comprise an adhesive layer having a first surface and a second surface, the first surface of the adhesive layer can be in intimate contact with the second surface of the backing film in the absence of the flame retardant layer or with the second surface of the flame retardant layer in the presence of the flame retardant layer. The adhesive layer can be a pressure-sensitive adhesive (PSA) layer. The adhesive layer may also comprise a flame retardant(s).

In an embodiment, the first surface of the topcoat can be a printable surface.

In an embodiment, the multi-layer label can further comprise a printing compatible layer having a first surface and a second surface, the second surface of the compatible layer in intimate contact with the first surface of the topcoat. The printing compatible layer may also comprise a flame retardant(s).

In an embodiment, the multi-layer label can further comprise a liner in intimate contact with the second surface of the adhesive layer.

In another aspect, the present invention provides a process for preparing a multi-layer label, comprising:
providing a backing film having a first surface and a second surface;
forming a topcoat layer comprising a polymeric matrix and a flame retardant(s) and having a first surface and a second surface to allow the second surface of the topcoat layer being in intimate contact with the first surface of the backing film;
wherein the label as a whole is in compliance with UL94 VTM-0 standard and comprises less than 900 ppm of chlorine, less than 900 ppm of bromine, and less than 1500 ppm of chlorine and bromine in combination.

In an embodiment, the process further comprises: forming a flame retardant layer comprising a binder and a flame retardant(s) and having a first surface and a second surface to allow the first surface of the flame retardant layer being in intimate contact with the second surface of the backing film.

In an embodiment, the process further comprises: forming an adhesive layer having a first surface and a second surface to allow the first surface of the adhesive layer being in intimate contact with the second surface of the backing film in the absence of the flame retardant layer.

In an embodiment, the process further comprises: forming an adhesive layer having a first surface and a second surface to allow the first surface of the adhesive layer being in intimate contact with the second surface of the flame retardant layer in the presence of the flame retardant layer.

The multi-layer label of the present invention complies with UL 94 VTM-0 standard and the IEC standard 61249-2-21, i.e., the multi-layer label has excellent flame retardant property and is an environment-friendly product. In addition, the multi-layer label of the present invention has a topcoat with a printable surface or a printing compatible layer and thus possesses good printability especially in color printing and thermal transfer printing. Moreover, the multi-layer label may have an adhesive layer and thus possesses adhesion characteristic. Furthermore, the multi-layer label as a whole is flexible, thereby achieving wrap around ability. The multi-layer label of the present invention may be applied to consumer electronic products and mass transportation.

### BRIEF DESCRIPTION OF THE DRAWINGS

FIG. 1 is an enlarged, cross-sectional view of an embodiment of multi-layer label in accordance with the present invention, in which 1 represents a topcoat comprising a flame retardant(s) and 2 represents a backing film.

FIG. 2 is an enlarged, cross-sectional view of an embodiment of multi-layer label in accordance with the present invention, in which 1 represents a topcoat comprising a flame retardant(s), 2 represents a backing film and 3 represents an adhesive layer free of flame retardant.

FIG. 3 is an enlarged, cross-sectional view of an embodiment of multi-layer label in accordance with the present invention, in which 1 represents a topcoat comprising a flame retardant(s), 2 represents a backing film, and 4 represents an adhesive layer comprising a flame retardant(s).

FIG. 4 is an enlarged, cross-sectional view of an embodiment of multi-layer label in accordance with the present invention, in which 1 represents a topcoat comprising a flame retardant(s), 2 represents a backing film, and 5 represents a flame retardant layer comprising a flame retardant(s).

FIG. 5 is an enlarged, cross-sectional view of an embodiment of multi-layer label in accordance with the present invention, in which 1 represents a topcoat comprising a flame retardant(s), 2 represents a backing film, 5 represents a flame retardant layer comprising a flame retardant(s), and 3 represents an adhesive layer free of flame retardant.

FIG. 6 is an enlarged, cross-sectional view of an embodiment of multi-layer label in accordance with the present invention, in which 1 represents a topcoat comprising a flame retardant(s), 2 represents a backing film, 5 represents a flame retardant layer comprising a flame retardant(s), and 4 represents an adhesive layer comprising a flame retardant(s).

### DETAILED DESCRIPTION OF THE PREFERRED EMBODIMENTS

The present invention is described generally with reference to the drawings for the purpose of illustrating the certain embodiments only, and not for the purpose of limiting the scope of the invention. In the drawings, like numerals are used to designate like parts throughout the same.

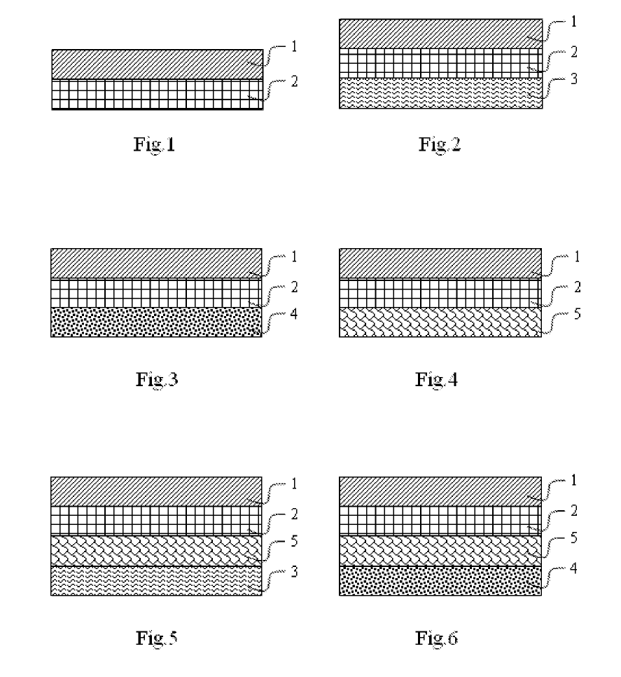

Turning to FIG. 1, the multi-layer label comprises: a backing film 2 having a first surface and a second surface, and a topcoat layer 1 comprising a polymeric matrix and a flame retardant(s) and having a first surface and a second surface, the second surface of the topcoat layer 1 in intimate contact with the first surface of the backing film 2.

As here used, “surface” is in distinction to “edge”. If rectangular in shape or configuration, a label will comprise two opposing surfaces joined by four edges (two opposing pairs of edges, each pair intersecting the other pair at right angles).

The term “in intimate contact” means that the surfaces of layers are in adhering contact with one another, e.g., as a coating is in contact with its substrate, with the understanding that the strength of the contact or, in other words, the strength of the adhesiveness of one layer to the other, will vary with the composition of the layers and the method of their joining, in which a primer for increasing the adhesive strength may be applied between the surfaces of layers.

In the context, the label can be of any size and shape and as such, so can the surfaces and edges, e.g., thin or thick, polygonal or circular, flat or wavy, etc.

The term “backing film” is also known as a plastic sheet, face-sheet, base layer, or substrate film, and acts as a substrate and support to provide with the label wrap-around ability. The wrap-around ability is important for using label in battery. In some cases, the backing film also provides the label flame retardancy.

The backing film 2 can be a polymeric film or a metal foil. Preferred materials for the backing film 2 are resins selected from polyester, ABS, polyacrylate, polycarbonate (PC), polyamide, polyimide (PI), polyamideimide, polyacetal, polyphenylene oxide (PPO), polysulfone, polyethersulfone (PES), polyphenylene sulfide, polyether ether ketone (PEEK), polyetherimide (PEI), metallized polyethylene terephthalate (PET), polyvinyl fluoride (PVF), polyethylene ether (PEE), fluorinated ethylene propylene (FEP), polyurethane (PUR), liquid crystal polymers (LCPs, class of aromatic polyester), polyvinylidene fluoride (PVDF), aramid fibers, DIALAMY (polymer alloys), polyethylene naphthalate (PEN), ethylene/tetrafluoroethylene (E/TFE), polyphenyl sulfone (PPSU) and polymers or polymer alloys containing one or more of these materials. Polyimide having a —CONHCO— group in polymer chain is a preferred resin for making the backing film 2.

The backing film 2 can be single- or multi-layered, filled (e.g., with a pigment or dye or flame retardant) or unfilled, smooth or rough surfaced (as described in U.S. Pat. No. 5,709,918), and microcavitated or not. Microcavitated films are typically prepared by introducing air into the resin during film extrusion, and such films generally exhibit lower specific gravity and improved print receptivity as compared to non-microcavitated films. Preferably the backing film is single-layered, unfilled, microcavitated and has a surface roughness with an arithmetical mean deviation of between 5 and 125 μm as determined by JIS B 0601. Representative backing films made of polyimide include those sold under “Kapton” brand by Dupont Co., “Apical” brand under Kaneka Limited Co. or “Upilex” brand by Ube industry limited Co.

The thickness of the backing film 2 can vary to convenience, but is typically between about 5 μm and about 100 μm, preferably between about 5 μm and about 75 μm, more preferably between about 10 μm and about 50 μm. The backing film 2 with too low thickness can easily break under tension and curl easily due to electrostatic attraction. Meanwhile, the backing film 2 with too high thickness is hard to wrap around a battery and has cost issue.

The topcoat layer 1 comprises a polymeric matrix and a flame retardant(s). The polymeric matrix can be a resin to provide with the topcoat layer 1 the abrasion resistance, the chemical resistance, the adhesion to the backing film 2 and the capacity of entrapping fillers such as pigments and flame retardants.

Representative resins for the topcoat layer 1 include epoxy, acrylic, polyurethane, phenoxy, polyester or phenolic resins, as well as mixtures thereof. Preferred resins are polyether or polyester type polyurethanes with a glass transition temperature (Tg) of equal to or lower than 32° C., such as those from Huntsman, Bayer, BASF, K. J. Quinn & Company Inc., Merquinsaor Co. or Lubrizol Advanced Materials, Inc., and phenoxy resins such as those from Dow Chemical, Huntsman, Shell or Inchem. Since phenoxy contains pendant hydroxyl groups, they are crosslinkable by any of various materials, e.g., melamines, isocyanates, phenolics, urea-formaldehydes and the like, which are reactive with hydroxyl groups in the presence of a catalyst such as dibutyl tin dilaurate. The phenoxy resins described in U.S. Pat. Nos. 6,261,730, 4,578,312 and 4,526,912 are representative. A mixture of a polyurethane resin and a phenoxy resin is more preferred.

The flame retardant in the topcoat layer 1 can be any suitable flame retardant substantially free of chlorine and bromine, and such flame retardant may also be called “non-halogen flame retardant” or “halogen-free flame retardant”. Representative flame retardants include: melamine based flame retardants; organophosphorus flame retardants; metal oxide hydrates, such as magnesium hydroxide hydrates, aluminum oxide hydrates; polysiloxanes; phosphates such as ammonium polyphosphates; and mixtures thereof. Ammonium polyphosphates are preferred.

In one embodiment, the flame retardant is one or more non-halogen intumescent flame retardant (NHIFR) materials. Such materials normally contain up to three components: a carbonic, an acid forming catalyst, and a blowing agent. These three functions may be contained in only one or two chemicals. Such materials usually contain phosphorus compounds, and often contain compounds of nitrogen, and are known as P/N flame retardants.

A wide variety of non-halogen phosphorus/nitrogen flame retardants are useful in the invention. Suitable flame retardants disclosed in EP0115871 comprise a nitrogen containing oligomer and ammonium polyphosphate. Other suitable flame retardants comprise ammonium polyphosphate in admixture with a variety of other flame retardant synergists and co-agents, fillers and pigments. Other suitable flame retardants are disclosed in EP 0204027 and comprise mixtures of ammonium polyphosphate, melamine cyanurate and a hydroxyalkyl derivative of isocyanuric acid, at least partially in the form of a homopolymer. Other suitable flame retardants are disclosed in EP 0413613A and comprise oligomeric phosphorus/nitrogen flame retardants containing a triazine nucleus, used in conjunction with ammonium polyphosphate. Other suitable flame retardants are disclosed in British Patent Application No. 9208926.7 and comprise a polyphosphonamide derivative used in conjunction with ammonium polyphosphate. Another useful class is the phosphate salts of polyols such as pentaerythritol. The suitable flame retardants are available from Clariant Co., Budenheim Co., Akzo Nobel Corp. etc.

The flame retardant can be in a form of particles. Typically, the flame retardant particles can be dispersed in the topcoat layer 1 randomly, nonhomogeneously or homogeneously. The particle size of the flame retardant usually does not exceed the thickness of the topcoat layer 1 and can vary to convenience, but typically is from about 0.1 to about 75 μm, preferably from about 0.5 to about 50 μm, more preferably from about 1 to about 30 μm. In general, ball milling is necessary to reduce the particle size to less than about 10 μm in order to produce a smooth topcoat layer with no visible particles.

The amount of flame retardant in the topcoat layer 1 is sufficient to render the overall label flame retardant, i.e., in compliance with UL94 VTM-0 standard, but not too much to compromise other properties of the label such as printability of the first surface of the topcoat layer 1. The amount of flame retardant in the topcoat layer 1 can vary to convenience, but typically, the minimum amount can be about 1%, about 2%, about 5%, about 10% or about 15% relative to the weight of the topcoat layer 1, and the maximum amount can be about 16%, about 18%, about 20%, about 25%, about 30%, about 40%, about 50%, about 60%, about 70% or about 75% relative to the weight of the topcoat layer 1.

The amount of flame retardant may also depend on the flammability of the resin of the topcoat layer 1 and the flammability and thickness of the backing film 2. For example, if the backing film 2 and/or the resin of the topcoat layer 1 are relatively flammable, a large amount of flame retardant should be used so that the overall label can meet UL94 VTM-0 standard, otherwise, for the backing film 2 and/or the resin of the topcoat layer 1 with a relatively weak flammability, a relatively small amount of flame retardant may be enough to meet UL94 VTM-0 standard.

The thickness of the topcoat layer 1 can vary to convenience, but typically is ranged from about 5 μm to about 100 μm, preferably from about 5 to about 75 μm, more preferably from about 10 to about 50 μm. Generally, the minimum thickness does not compromise the topcoat's opacity and whiteness. The thickness of the topcoat layer 1 also depends on the flammability of the topcoat layer 1 and/or the flammability and thickness of the backing film 2. For example, if the backing film 2 is relatively flammable, a large thickness of the topcoat layer 1 with relatively high nonflammability may have to be used. If the backing film 2 is relatively nonflammable, a small thickness of the topcoat layer 1 could be enough. However, too thick topcoat layer 1 can jeopardize the flexibility of the label. If the topcoat layer 1 has to comprise an insufficient amount of flame retardant in some situations (e.g., for balancing various properties of the overall label), a relatively nonflammable backing film 2 can be used and the thickness of the topcoat layer 1 can be reduced to a level that the overall label can still meet UL94 VTM-0 standard.

The topcoat layer 1 may further comprise a pigment, such as titanium dioxide, lithopone and/or zinc oxide for opacity and whiteness. Titanium dioxide is preferred. The amount of pigment depends on the opacity and whiteness of the topcoat layer 1, but typically is ranged from about 5 to about 60 wt %, preferably about 10 to about 50 wt % relative to the weight of the topcoat layer 1.

In one specific embodiment, the topcoat layer 1 comprises a flame retardant to contribute to the flame retardancy of the topcoat and the whole structure, a polyurethane resin to contribute to the abrasion resistance and the adhesion of the topcoat layer 1 to the backing film 2, and a phenoxy resin to contribute to the chemical resistance and the flame retardancy of the topcoat layer 1. The weight ratio of the polyurethane resin to the phenoxy resin can be from 0:100 to 100:0, preferably 70:30 to 10:90, more preferably 65:35 to 45:55, most preferably 60:40 to 50:50. The topcoat layer 1 may further comprise a cross-linker which contributes to the abrasion resistance and chemical resistance of the topcoat layer 1 by cross-linking the phenoxy resin. The topcoat layer 1 may also further comprise a pigment which contributes to the opacity and whiteness of the topcoat. For example, a composition for forming the topcoat layer 1 can comprise a phenoxy resin in an amount of about 5 to about 45% relative to the weight of the topcoat layer 1; a polyurethane resin in an amount of about 15 to 45% relative to the weight of the topcoat layer 1; a flame retardant in an amount of about 5 to 50% relative to the weight of the topcoat layer 1; and a pigment such as titanium dioxide in an amount of about 10 to 50% relative to the weight of the topcoat layer 1.

The topcoat layer 1 may further comprise a primer, which may increase the adhesive strength of the flame retardant particle-containing topcoat layer 1 to the backing film 2. Conventional primers include glycidyl ether epoxy/phenol-blocked isocyanates (which require heating to 220° C. or greater to unblock the isocyanate), isocyanurates, and condensation products of (i) resorcinol and formaldehyde, or (ii) resorcinol, formaldehyde and chlorophenol (commonly known as chlororesorcinol). Preferably the primer layer comprises a mixture or blend of resorcinol, formaldehyde (or a source of formaldehyde) and styrene butadiene vinyl pyridine latex solution (commonly known as resorcinol-formaldehyde latex resin).

The topcoat layer 1 can be prepared by applying a topcoat layer solution to the backing film 2 via any conventional apparatus and process, such as slot die, reverse roll-coating, knife over roll, gravure or Mayer rod. The topcoat layer solution can be formed by dissolving a resin, such as the aforementioned phenoxy resin and polyester-based polyurethane resin, in a suitable solvent, e.g. acetone, methyl ethyl ketone or tetrahydrofuran at room temperature, and then slowly adding a flame retardant, optionally a pigment, a cross-linker and/or a catalyst while the solution is agitated with a high shear mixer. The topcoat layer 1 can also be formed by flexco printing or screen printing.

The backing film 2 with the topcoat solution can be then passed through a series of drying ovens to form the topcoat layer 1 on the backing film 2, after which the backing film 2 may be finally slit to an appropriate size and then converted into small labels by die cutting to form the multi-layer label as shown in FIG. 1. It may be printed before or after being slit and converted into small labels. The multi-layer label can also be further rolled and ready for a next step, e.g., receiving an adhesive coating as discussed below.

Turning to FIG. 2, the multi-layer label in accordance with the present invention may have a topcoat layer 1, a backing film 2 and an adhesive layer 3. The topcoat layer 1 and backing film 2 can be the same as those abovementioned, and the terms used here have the same meanings as above unless indicated in contrary.

The adhesive layer 3 is in intimate contact with the backing film 2. The adhesive layer 3 contributes to the wrap-around performance of the label. The adhesive layer 3 can be a pressure-sensitive adhesive layer. The use of the pressure-sensitive adhesive layer also allows for repositioning the label after it has been secured. Acrylic, rubber based and silicone based pressure sensitive adhesives are the representatives of the various types of adhesives that can be used in this invention. For reasons of high shear strength and temperature stability, the acrylic based adhesives are preferred. “Aroset” series from Ashland, “Durotak” series from National Starch and “GMS” series from Cytec are preferred acrylic based adhesives.

The thickness of the adhesive layer 3 may also depend on the flammability of itself and the flammability and thickness of other parts of the flame retardant labels. For example, if the adhesive layer 3 is relatively flammable, its thickness should be small enough to ensure the overall label meeting UL 94 VTM-0 standard, but still large enough to ensure the desired adhesive power. The thickness of the adhesive layer 3 is typically at least about 10 μm, preferably at least about 20 μm and more preferably at least about 25 μm, and it typically does not exceed about 75 μm to ensure good adhesive performance and meet UL 94 VTM-0 standard.

The adhesive layer 3 may be prepared by applying an adhesive coating on the backing film 2. The adhesive coating can be applied to the backing film 2 via any conventional processes, such as slot die, reverse roll coating, knife over roll, gravure, Mayer rod, and coating transfer from a release paper. Then the backing film 2 can be passed through a series of drying ovens, after which the film may be finally slit to an appropriate size and then converted into small labels by die cutting to form the multi-layer label as shown in FIG. 2. It may be printed before or after being slit and converted into small labels.

Turning to FIG. 3, the multi-layer label in accordance with the present invention may have a topcoat layer 1, a backing film 2 and a flame retardant-containing adhesive layer 4. The topcoat layer 1 and backing film 2 can be the same as abovementioned, and the terms used here have the same meanings as above unless indicated in contrary.

The flame retardant-containing adhesive layer 4 can be in intimate contact with the backing film 2. The flame retardant-containing adhesive layer 4 can be a flame retardant-containing pressure-sensitive adhesive layer.

The flame retardant-containing adhesive layer 4 can be prepared by using the same materials via the same way for forming the adhesive layer 3 as discussed above, except that a flame retardant as abovementioned is added to the adhesive. The amount of the flame retardant in the flame retardant-containing adhesive layer 4 is sufficient to render the overall label to meet UL 94 VTM-0 standard, typically ranging from about 5 to about 75%, preferably from about 10 to about 50% relative to the weight of the flame retardant-containing adhesive layer 4.

The thickness of the adhesive layer 4 also depends on the flammability of itself and the flammability and thickness of other parts of the flame retardant label. For example, if the adhesive layer 4 contains a relatively small amount of flame retardant and thus is still relatively flammable, other parts of the label should be relatively nonflammable and the thickness of the adhesive layer 4 should be small enough to ensure the overall label meeting UL 94 VTM-0 standard. The thickness of the adhesive layer 4 is typically at least about 10 μm, preferably at least about 20 μm and more preferably at least about 25 μm, and it typically does not exceed about 100 μm.

The flame retardant in the adhesive layer 4 can be the same or different flame retardant as described above. Representative flame retardants include: melamine based flame retardants; organophosphorus flame retardants; metal oxide hydrates, such as magnesium hydroxide hydrates, aluminum oxide hydrates; polysiloxanes; phosphates such as ammonium polyphosphates; and mixtures thereof. Ammonium polyphosphates are preferred. Typically, the flame retardant particles can be in a form of particles and dispersed in the adhesive layer 4 randomly, nonhomogeneously or homogeneously. The particle size of the flame retardant usually does not exceed the thickness of the adhesive layer 4 and can vary to convenience, but typically is between about 0.1 and about 75 μm, preferably between about 0.5 and about 50 μm.

The flame retardant-containing adhesive layer 4 can be prepared by applying a flame retardant-containing adhesive coating on the backing film 2 via any conventional processes, such as slot die, reverse roll coating, knife over roll, gravure, Mayer rod, and coating transfer from a release paper. Then the backing film 2 can be passed through a series of drying ovens, after which the film may be finally slit to an appropriate size and then converted into small labels by die cutting to form the multi-layer label as shown in FIG. 3. It may be printed before or after being slit and converted into small labels.

Turning to FIG. 4, the multi-layer label of the present invention may have a backing film 2, a topcoat layer 1 and a flame retardant layer 5. The use of the flame retardant layer 5 provides more flexibility for designing the multi-layer label of the present invention.

The topcoat layer 1 and backing film 2 can be the same as abovementioned, and the terms used here have the same meanings as above unless indicated in contrary. The same materials as used in the multi-layer label of FIG. 1 are also used here.

The flame retardant layer 5 comprises a binder and a flame retardant(s). The binder can be an organic binder such as a wax or a resin to provide with the flame retardant layer 5 the adhesion to the backing film 2 and the capacity of entrapping fillers such as pigments and flame retardants.

Representative resins for the flame retardant layer 5 include epoxy, acrylic, polyurethane, phenoxy, polyester or phenolic resins. Preferred resins are polyether or polyester type polyurethanes with a glass transition temperature (T_{g}) of equal to or lower than 32° C., such as those from Huntsman, Bayer, BASF, K. J. Quinn & Company Inc, Merquinsaor Co. or Lubrizol Specialty Chemical, and phenoxy resins such as those from Dow Chemical, Huntsman, Shell or Inchem. Since phenoxy contains pendant hydroxyl groups, they are crosslinkable by any of various materials, e.g., melamines, isocyanates, phenolics, urea-formaldehydes and the like, which are reactive with hydroxyl groups in the presence of a catalyst such as dibutyl tin dilaurate. The phenoxy resins described in U.S. Pat. Nos. 6,261,730, 4,578,312 and 4,526,912 are representative. A mixture of a polyurethane resin and a phenoxy resin is more preferred.

The flame retardant in the flame retardant layer 5 can be the same or different flame retardant in the topcoat layer 1 as described above. Representative flame retardants include: melamine based flame retardants; organophosphorus flame retardants; metal oxide hydrates, such as magnesium hydroxide hydrates, aluminum oxide hydrates; polysiloxanes; phosphates such as ammonium polyphosphates; and mixtures thereof. Ammonium polyphosphates are preferred.

The flame retardants can be in a form of particles. Typically, the flame retardant particles can be dispersed in the flame retardant layer 5 randomly, nonhomogeneously or homogeneously. The particle size of the flame retardant usually does not exceed the thickness of the flame retardant layer 5 and can vary to convenience, but typically is between about 0.1 and about 75 μm, preferably between about 0.5 and about 50 μm.

The amount of flame retardant in the flame retardant layer 5 together with the amount of flame retardant in the topcoat layer 1 is sufficient to render the overall label nonflammable, i.e., in compliance with UL94 VTM-0 standard. The amount of flame retardant in the flame retardant layer 5 can vary to convenience, being identical to or different from that in the topcoat layer 1, but typically, the minimum amount can be about 1%, about 2%, about 5%, about 10% or about 15% relative to the weight of the flame retardant layer 5, and the maximum amount can be about 16%, about 18%, about 20%, about 25%, about 30%, about 40%, about 50%, about 60% or about 70% relative to the weight of the flame retardant layer 5.

The thickness of the flame retardant layer 5 can vary to convenience, but typically is ranged from about 5 to about 100 μm, preferably about 5 to about 75 μm, more preferably about 10 to about 50 μm.

The flame retardant layer 5 may be formed on the backing film 2 during, before or after the topcoat layer 1 is formed on the backing film 2. The processes for forming the flame retardant layer 5 can be a conventional process, such as slot die, reverse roll coating, knife over roll, gravure, Mayer rod, and coating transfer from a release paper. Then the backing film can be passed through a series of drying ovens, after which the backing film is finally slit to an appropriate size and then converted into small labels by die cutting. It may be printed before or after being slit and converted into small labels.

Turning to FIG. 5, the multi-layer label of the present invention can also be prepared by applying an adhesive layer 3 as described in FIG. 2 on the flame retardant layer 5 of the multi-layer label of FIG. 4. The materials and processes used here for forming the multi-layer label of FIG. 5 are also the same as abovementioned. The adhesive layer 3 preferably is a pressure-sensitive adhesive layer 3.

Turning to FIG. 6, the multi-layer label of the present invention can also be prepared by applying a flame retardant-containing adhesive layer 4 as described in FIG. 3 on the flame retardant layer 5 of the multi-layer label of FIG. 4. The materials and processes used here for forming the multi-layer label of FIG. 6 are also the same as abovementioned. The flame retardant-containing adhesive layer 4 preferably is a flame retardant-containing pressure-sensitive adhesive layer.

The multi-layer label of the present invention meets the requirements of UL94 VTM-0 standard and IEC 61249-2-21 standard.

The color printability, thermal transfer printability and the adhesion performance of the multi-layer label of the present invention are excellent.

As compared to current labels in the art, such as MZ1026 from Avery Dennison and XF-541 from Polyonics, the multi-layer label of the present invention is distinctive in many aspects, such as adding halogen-free flame retardant(s) to the topcoat and/or the adhesive layer, adding the flame retardant layer, and controlling the thickness of each layer to meet the requirements of UL94 VTM-0 standard and IEC 61249-2-21 standard.

The flame retardancy rating test is carried out according to the test standard of UL94 VTM. The multi-layer label of the present invention is rated as VTM-0. The UL94 VTM test procedure is as follows: constructing 8 inch long by 0.5 inch diameter tube from each sample, marking the tube 5 inches from the bottom, applying flame to the base of tube suspended in a test chamber for 3 seconds, withdrawing flame and recording combustion time (after-flame time t₁), reapplying the flame to the same sample again for 3 seconds, and withdrawing and recording combustion time (after-flame time t₂) and glow time (after-glow time t₃). Each test is comprised of 5 specimens.

The criteria for UL94 VTM-0 are as follows: after-flame time for each individual specimen t₁ or t₂ is less than 10 s; total after-flame time for any condition set (t₁ plus t₂ for the 5 specimens) is less than 50 s; after-flame time plus after-glow time for each individual specimen after the second flame application (t₂ plus t₃ for the 5 specimens) is less than 30 s; no after-flame or afterglow of any specimen is up to the 5 inch mark; and no cotton indicator is ignited by flaming particles or drops.

The halogen free test is carried out according to the test standards of IEC (International Electromechanical Commission) standard 61249-2-21, in which the criteria are: chlorine is less than 900 ppm, bromine is less than 900 ppm, and the combination of chlorine and bromine is less than 1500 ppm.

Without the limitation of any theories, it is believed that all of the components of the label contribute to the compliance of the halogen free requirement by containing no halogen in the whole construction. The UL 94 VTM-0 flame retardancy of the label without an adhesive layer is achieved by the joint effort of the backing film, the topcoat layer containing a flame retardant(s) and optionally the flame retardant layer. The UL94 VTM-0 flame retardancy of the label with an adhesive layer is achieved by the joint effort of the backing film, the topcoat layer containing a flame retardant(s), the adhesive layer optionally containing a halogen free flame retardant(s), and optionally the flame retardant layer.

The label of the present invention can be used for consumer electronic products, e.g. PCB (Printed Circuit Board) labels, and other applications in need of (white or color) identification solution with UL94 VTM-0 and halogen free requirement such as mass transportation.

### SPECIFIC MODES FOR CARRYING OUT THE INVENTION

The following examples are to further illustrate the present invention, but are not intended to limit the protection scope of the present invention.

### Example 1

Labels of the structure as shown in FIG. 1 were prepared by roll-coating a topcoat layer solution on a first surface of a backing film, and then drying at 150° C. for 2 minutes to form a topcoat layer on the first surface of the backing film.

Twelve labels were obtained by using six backing films and two topcoat layer solutions 1 and 2 according to the above process. The six backing films were PI, PEI, FR-PC, FR-PET, Al, PVF. Two topcoat layer solutions 1 and 2 were prepared as follows. The topcoat layer solution 1 was used to form a topcoat layer without flame retardant (Non-FR topcoat), and the topcoat layer solution 2 was used to form a topcoat layer with flame retardant (FR topcoat).

Preparation of the topcoat layer solution 1: In a high shear mixer (Cowles™) 40 g of phenoxy resin (Inchem PKHH) and 60 g of polyurethane resin (Lubrizol Estane 5703) were dissolved in 450 mL of cyclohexanone at room temperature, and 80 g of titanium dioxide (Dupont Ti-Pure R-900) as pigment, 4.5 g of polyisocyanate (BASF Basonat HB 175 MP/X) as cross-linker and 0.2 g of dibutyltin diacetate (Sigma Aldrich) as catalyst were slowly added and vigorously agitated to obtain the topcoat layer solution 1.

Preparation of the topcoat layer solution 2: In a high shear mixer (Cowles™) 40 g of phenoxy resin (Inchem PKHH) and 60 g of polyurethane resin (Lubrizol Estane 5703) were dissolved in 450 mL of cyclohexanone at room temperature, and 27 g of ammonium polyphosphate (Clariant Exolit AP 422) as flame retardant, 80 g of titanium dioxide (Dupont Ti-Pure R-900) as pigment, 4.5 g of polyisocyanate (BASF Basonat HB 175 MP/X) as cross-linker and 0.2 g of dibutyltin diacetate (Sigma Aldrich) as catalyst were slowly added and vigorously agitated to obtain the topcoat layer solution 2.

The twelve labels were tested according to UL94 VTM-0 standard, and the results were shown in Table 1.

TABLE 1
Flame retardancy performance of labels using different backing films

| Backing film | | Topcoat layer | | |
|---|---|---|---|---|
| | Thickness | topcoat | Thickness | Flame retardancy performance |
| Resin | (μm) | layer | (μm) | (t₁ + t₂) |
| PI | 25 | Non-FR | 18 | Complete burning |
| PI | 25 | FR | 18 | 2-4 s |
| PEI | 30 | Non-FR | 18 | Complete burning |
| PEI | 30 | FR | 18 | 2-4 s |
| FR-PC | 60 | Non-FR | 18 | Complete burning, dripping |
| FR-PC | 60 | FR | 18 | 8-10 s |
| FR-PET | 45 | Non-FR | 18 | 8-10 s |
| FR-PET | 45 | FR | 18 | 2-4 s |
| Al | 25 | Non-FR | 18 | Complete burning |
| Al | 25 | FR | 18 | 0-2 s |
| PVF | 25 | Non-FR | 18 | Complete burning |
| PVF | 25 | FR | 18 | 10-12 s |

As shown in Table 1, the use of flame retardant significantly improved the flame retardancy performances of the labels of all types of backing film.

### Example 2

Labels of the structure as shown in FIG. 2 were prepared by roll-coating a topcoat layer solution on a first surface of a backing film, drying at 150° C. for 2 minutes to form a topcoat layer on the first surface of the backing film, then roll-coating an adhesive layer solution on a second surface of the backing film, and drying at 90° C. for 4 minutes to form an adhesive layer on the second surface of the backing film.

Twelve labels were obtained according to the above process by using the six backing films and the two topcoat layer solutions 1 and 2 as described in Example 1, and an acrylic adhesive (National starch, Durotak 180-129A) to form the adhesive layer without flame retardant (non-FR adhesive layer). The obtained labels were tested according to UL94 VTM-0 standard, and the results were shown in Table 2.

TABLE 2
Flame retardancy performance of labels with non-FR adhesive layer

| Backing film | | Topcoat layer | | Adhesive | Flame retardancy |
|---|---|---|---|---|---|
| | Thickness | topcoat | Thickness | layer | performance |
| Resin | (μm) | layer | (μm) | (μm) | (t₁ + t₂) |
| PI | 25 | Non-FR | 18 | 20 | Complete burning |
| PI | 25 | FR | 18 | 20 | 6-8 s |
| PEI | 30 | Non-FR | 18 | 20 | Complete burning |
| PEI | 30 | FR | 18 | 20 | 8-10 s |
| FR-PC | 60 | Non-FR | 18 | 20 | Complete |
| | | | | | burning, dripping |
| FR-PC | 60 | FR | 18 | 20 | 12-14 s |
| FR-PET | 45 | Non-FR | 18 | 20 | 15-20 s |
| FR-PET | 45 | FR | 18 | 20 | 8-10 s |
| Al | 25 | Non-FR | 18 | 20 | Complete burning |
| Al | 25 | FR | 18 | 20 | 4-6 s |
| PVF | 25 | Non-FR | 18 | 20 | Complete burning |
| PVF | 25 | FR | 18 | 20 | 12-15 s |

From the Tables 1 and 2, it can be seen that the structures with topcoat layer containing flame retardant always have better flame retardancy performance than those with topcoat layer not containing flame retardant. Furthermore, the structure with aluminum backing film has the best flame retardancy, decreasing in the order Al>PI˜PET>PEI>PC>PVF. Since aluminum has wrinkling issue and FR-PET has cost and thickness issues, PI is preferred.

### Example 3

The same materials and process as described in Example 2 were used, and labels with typical topcoat layer thickness (18 μm), non-FR adhesive layer thickness (20 μm) and varying PI backing film thickness were prepared accordingly. The flame retardancy performances of the obtained labels were shown in Table 3.

TABLE 3
Effects of backing film thickness on flame retardancy performance

| PI thickness (μm) | Non-FR topcoat | FR topcoat |
|---|---|---|
| 12 | Complete burning | 8-10 s |
| 20 | Complete burning | 6-8 s |
| 25 | Complete burning | 6-8 s |
| 125 | 2-4 s | 0-2 s |

From Table 3, as for PI backing film, the thicker the backing film, the better the flame retardancy. Usually, backing film thickness can range from 12 to 125 μm. Film with too low thickness can easily break under tension and curl easily due to electrostatic attraction. Meanwhile, film with too high thickness is hard to wrap around a battery and has cost issue. Since PI with 25 μm thickness has higher mechanical stability than thinner ones and has better conformability to wrap around a battery, this thickness is preferred.

### Example 4

The same materials and process as described in Example 2 were used, and labels with typical PI backing film thickness (25 μm), non-FR adhesive layer thickness (20 μm) and varying topcoat layer thickness were prepared accordingly. The flame retardancy performances of the obtained labels were shown in Table 4.

TABLE 4
Effects of topcoat layer thickness on flame retardancy performance

| Topcoat thickness (μm) | Non-FR topcoat | FR topcoat |
|---|---|---|
| 10 | 8-10 s | 4-6 s |
| 18 | Complete burning | 6~8 s |
| 50 | Complete burning | 8-10 s |

From Table 4, as for PI backing film, the thinner the topcoat layer, the better the flame retardancy. Usually, topcoat layer thickness can range from 10 μm to 50 μm. Too thin topcoat layer can compromise the opacity and whiteness while too thick topcoat layer can jeopardize flame retardancy and raise cost. Thus, as for PI backing film, topcoat layer with 20 μm is preferred for the overall performance by balancing opacity, whiteness, flame retardancy and cost.

### Example 5

The same materials and process as described in Example 2 were used, and labels with typical PI backing film thickness (25 μm), topcoat layer thickness (18 μm) and varying non-FR adhesive layer thickness were prepared accordingly. The flame retardancy performances of the obtained labels were shown in Table 5.

TABLE 5
Effects of non-FR adhesive layer thickness on flame retardancy
performance

| Non-FR adhesive thickness (μm) | Non-FR topcoat | FR topcoat |
|---|---|---|
| 10 | Complete burning | 2-4 s |
| 20 | Complete burning | 6~8 s |
| 40 | Complete burning | 8-10 s |

From Table 5, as for PI backing film, the thinner the non-FR adhesive layer, the better the flame retardancy. Usually, non-FR adhesive layer thickness can range from 10 μm to 40 μm. Too thin adhesive layer can cause lifting problem while too thick adhesive layer can compromise flame retardancy and induce oozing during die cut. Thus, as for this typical situation with PI backing film, adhesive layer with 20 μm is preferred for the overall performance.

### Example 6

The same materials and process as described in Example 2 were used, except an adhesive layer solution containing a flame retardant as described as follows was used to replace the adhesive layer solution without flame retardant in order to form an adhesive layer with flame retardant (FR-adhesive layer), and labels with typical PI backing film thickness (25 μm), topcoat layer thickness (18 μm) and varying FR adhesive layer thickness were prepared accordingly.

Preparation of the adhesive layer solution with a flame retardant: In a high shear mixer (Cowles™), 8 g of ammonium polyphosphate (Clariant Exolit AP 422) as flame retardant was added to 192 g of acrylic adhesive (National starch, Durotak 180-129A) and vigorously agitated to obtain the FR adhesive layer solution.

The flame retardancy performances of the obtained labels were shown in Table 6.

TABLE 6
Effects of FR adhesive layer thickness on flame retardancy performance

| FR adhesive thickness (μm) | FR topcoat |
|---|---|
| 10 | 2-4 s |
| 20 | 4-6 s |
| 70 | 8-10 s |

From Tables 5 and 6, as for this typical situation with PI backing film, the non-FR adhesive layer typically does not exceed about 40 μm to achieve VTM-0 performance, while the FR adhesive layer thickness can be extended to 100 μm which provide more flexibility for designing multi-layer labels.

### Example 7

The same materials and process as described in Example 2 were used, except the contents of flame retardant in the topcoat layer as shown in Table 7 were used, and labels with typical PI backing film thickness (25 μm), topcoat layer thickness (18 μm) and non-FR adhesive layer thickness (20 μm) were prepared accordingly. The flame retardancy performances of the obtained labels were shown in Table 7.

TABLE 7
Effects of flame retardant contents in topcoat layer on flame
retardancy performance

| Flame retardant content | Flame retardancy |
|---|---|
| of topcoat layer (%) | performance (t₁ + t₂) |
| 0 | Complete burning |
| 6 | 10~12 s |
| 12 | 6~8 s |
| 18 | 6~8 s |
| 24 | 8~10 s |

From Table 7, the more flame retardant (FR), the better flame retardancy performance, but the FR performance reaches a plateau when more FR is added. Thus, a flame retardant content of topcoat layer is preferably 12% relative to the weight of topcoat layer.

### Example 8

### Preparation of a Halogen Free UL94 VTM-0 Label with Phenoxy Resin as Polymeric Matrix of Topcoat Layer

Preparation of the topcoat layer solution 3: In a high shear mixer (Cowles™) 100 g of phenoxy resin (Inchem PKHH) was dissolved in 450 mL of cyclohexanone at room temperature, and 20 g of ammonium polyphosphate (Clariant Exolit AP 422) as flame retardant, 80 g of titanium dioxide (Dupont Ti-Pure R-900) as pigment, 7.5 g of polyisocyanate (BASF Basonat HB175MP/X) as cross-linker and 0.3 g of dibutyltin diacetate (Sigma Aldrich) as catalyst were slowly added and vigorously agitated to obtain the topcoat layer solution 3.

The obtained topcoat layer solution 3 was then roll coated on a first surface of PI film (25 um) and dried at 150° C. for 2 minutes to form a topcoat layer; then an acrylic adhesive solution (National starch, Durotak 180-129A) was roll coated on a second surface of the PI film and dried at 90° C. for 4 minutes to form an adhesive layer. The label was rated UL 94 VTM-0 (t₁+t₂: 6˜8 s).

### Example 9

### Preparation of a Halogen Free UL94 VTM-0 Label with Polyurethane Resin as Polymeric Matrix of Topcoat Layer

Preparation of the topcoat layer solution 4: In a high shear mixer (Cowles™) 100 g of polyurethane resin (Lubrizol Estane 5703) was dissolved in 450 mL of cyclohexanone at room temperature, and 40 g of ammonium polyphosphate (Clariant Exolit AP 422) as flame retardant, 80 g of titanium dioxide (Dupont Ti-Pure R-900) as pigment were slowly added and vigorously agitated to obtain the topcoat layer solution 4.

The obtained topcoat layer solution 4 was then roll coated on the first surface of PI film (25 um) and dried at 150° C. for 2 minutes to form a topcoat layer; then an acrylic adhesive solution (National starch, Durotak 180-129A) was roll coated on the second surface of the PI film and dried at 90° C. for 4 minutes to form an adhesive layer. The label was rated UL 94 VTM-0 (t₁+t₂: 6˜8 s).

### Example 10

The same materials and process as described in Example 2 were used, and a typical label composed of FR topcoat layer (18 μm), PI backing film (25 μm) and non-FR adhesive layer (20 μm) was prepared accordingly. The physical properties of the obtained label were measured and shown in Table 8, and the performances of the obtained label were shown in Tables 9 and 10.

TABLE 8
Physical properties of the typical label

| Physical | | |
|---|---|---|
| properties | Test methods | Typical results |
| Thickness | ASTM D1000 | |
| | Topcoat | 18 μm |
| | Substrate | 25 μm |
| | Adhesive | 20 μm |
| | Total | 63 μm |
| Adhesion to: | ASTM D 1000 | |
| Stainless Steel | 20 min dwell | 21.9 oz/in |
| | 24 hour dwell | 30.4 oz/in |
| ABS | 20 min dwell | 23.7 oz/in |
| | 24 hour dwell | 35.4 oz/in |
| Tack | ASTM D 2979 | 200 g |
| | Polyken ™ Probe Tack | |
| | 1 second dwell | |
| Drop Shear | PSTC-7 | >160 hours |
| Flammability | UL 94 VTM | |
| | Average Burn Time | VTM-0, t1 + t2: 6-8 seconds |

TABLE 9
Performances of the typical label as printed with R6200 ribbon using a
Bradyprinter ™ THT Model 600X-Plus thermal transfer printer.

| Performance | | |
|---|---|---|
| properties | Test methods | Typical results |
| THT | R6200, Code 29 size, 6.4 mils, | 100 continuous print, no |
| Printable | horizontal barcode, printed with | visual defects, optimal |
| | 600X-Plus | burn temp ±3. Barcode |
| | | verifier quality B and |
| | | above. |
| Abrasion | Taber Abraser, CS-10 grinding | No visual effect, barcode |
| Resistance | wheels, 25 cycles, 250 g/arm | verifier quality C and |
| | | above |
| Chemical | Isopropanol rubbing, 10 cycles, | No visual effect |
| Resistance | 200 g force | |

The printed samples were laminated to aluminum and allowed to dwell for 24 hours before being exposed to the indicated environmental conditions.

TABLE 10
Performance of the typical label as printed with an ink (Toyo
SDSL blue N) using a flexographic printer (anilox 600 line/inch) and
followed by a varnish (Radcure corp., Rad-kote 159LV).

| Performance | | |
|---|---|---|
| properties | Test methods | Typical results |
| Preprintable | 3B~5B, 3M tape test | No ink |
| | | delamination |
| Abrasion | Taber Abraser, CS-10 grinding wheels, | No topcoat visual |
| Resistance | 25 cycles, 250 g/arm | decolorization |
| | Crockmeter test, 3000 cycles | No topcoat visual |
| | | decolorization |

The printed samples were laminated to aluminum and allowed to dwell for 24 hours before being exposed to the indicated environmental conditions.

1. A multi-layer label, comprising:
a backing film having a first surface and a second surface; and
a topcoat layer comprising a polymeric matrix and a flame retardant and having a first surface and a second surface, the second surface of the topcoat layer in intimate contact with the first surface of the backing film;
wherein the multi-layer label further comprises a flame retardant layer comprising a binder and a flame retardant and having a first surface and a second surface, and the first surface of the flame retardant layer is in intimate contact with the second surface of the backing film, or the multi-layer label further comprises an adhesive layer having a first surface and a second surface, the first surface of the adhesive layer is in intimate contact with the second surface of the backing film; and
wherein the label as a whole is in compliance with UL94 VTM-0 standard and comprises less than 900 ppm of chlorine, less than 900 ppm of bromine, and less than 1500 ppm of chlorine and bromine in combination.

2. (canceled)

3. (canceled)

4. The multi-layer label according to claim 1, the multi-layer label further comprises an adhesive layer having a first surface and a second surface, the first surface of the adhesive layer is in intimate contact with the second surface of the flame retardant layer.

5. The multi-layer label according to claim 1, wherein the backing film is a metal foil or a film of a resin selected from polyester, ABS, polyacrylate, polycarbonate (PC), polyamide, polyimide (PI), polyamideimide, polyacetal, polyphenylene oxide (PPO), polysulfone, polyethersulfone (PES), polyphenylene sulfide, polyether ether ketone (PEEK), polyetherimide (PEI), metallized polyethylene terephthalate (PET), polyvinyl fluoride (PVF), polyethylene ether (PEE), fluorinated ethylene propylene (FEP), polyurethane (PUR), liquid crystal polymers (LCPs, class of aromatic polyester), polyvinylidene fluoride (PVDF), aramid fibers, DIALAMY (polymer alloys), polyethylene naphthalate (PEN), ethylene/tetrafluoroethylene (E/TFE), polyphenyl sulfone (PPSU), and a mixture thereof.

6. The multi-layer label according to claim 1, wherein the backing film has a thickness of between about 5 μm and about 100 μm.

7. The multi-layer label according to claim 1, wherein the topcoat layer comprises a polymeric matrix selected from epoxy, acrylic, polyurethane, phenoxy, polyester, phenolic resins and mixtures thereof, and a flame retardant selected from melamine based flame retardants, organophosphorus flame retardants, metal oxide hydrates, polysiloxanes, ammonium polyphosphates and mixtures thereof.

8. The multi-layer label according to claim 1, wherein the polymeric matrix comprises 0-100 weight parts of polyurethane resin and 0-100 weight parts of phenoxy resin.

9. The multi-layer label according to claim 1, wherein the amount of the flame retardant in the topcoat layer is between about 5% and about 70% relative to the weight of the topcoat layer.

10. The multi-layer label according to claim 1, wherein the topcoat layer has a thickness of between about 5 μm and about 100 μm.

11. The multi-layer label according to claim 1, wherein the topcoat layer further comprises a pigment.

12. The multi-layer label according to claim 1, the flame retardant layer comprises a binder selected from epoxy, acrylic, polyurethane, phenoxy, polyester, phenolic resins, and mixtures thereof, and a flame retardant selected from melamine based flame retardants, organophosphorus flame retardants, metal oxide hydrates, polysiloxanes, ammonium polyphosphates and mixtures thereof.

13. The multi-layer label according to claim 1, wherein the amount of the flame retardant in the flame retardant layer is between about 5% and about 70% relative to the weight of the flame retardant layer.

14. The multi-layer label according to claim 1, wherein the flame retardant layer has a thickness of between about 5 μm and about 100 μm.

15. The multi-layer label according to claim 1, the adhesive layer is a pressure-sensitive adhesive (PSA) layer.

16. The multi-layer label according to claim 1, the adhesive layer comprises a flame retardant in an amount between about 5 and about 70% relatively to the weight of the adhesive layer.

17. The multi-layer label according to claim 1, wherein the adhesive layer has a thickness of between about 5 μm and about 75 μm.

18. The multi-layer label according to claim 1, wherein the multi-layer label further comprises a liner in intimate contact with the second surface of the adhesive layer.

19. A process for making the multi-layer label according to claim 1, comprising:
providing a backing film having a first surface and a second surface;
forming a topcoat layer comprising a polymeric matrix and a flame retardant and having a first surface and a second surface to allow the second surface of the topcoat layer being in intimate contact with the first surface of the backing film;
forming a flame retardant layer comprising a binder and a flame retardant and having a first surface and a second surface to allow the first surface of the flame retardant layer being in intimate contact with the second surface of the backing film, or forming an adhesive layer having a first surface and a second surface to allow the first surface of the adhesive layer being in intimate contact with the second surface of the backing film;
wherein the label as a whole is in compliance with UL94 VTM-0 standard and comprises less than 900 ppm of chlorine, less than 900 ppm of bromine, and less than 1500 ppm of chlorine and bromine in combination.

20. (canceled)

21. (canceled)

22. The process according to claim 19, further comprising:
forming an adhesive layer having a first surface and a second surface to allow the first surface of the adhesive layer being in intimate contact with the second surface of the flame-retardant layer.

23. An article comprising the multi-layer label according to claim 1.

24. Use of the multi-layer label according to claim 1 in electronic products and mass transportation.
